(19) United States
(12) Patent Application Publication
(10) Pub. No.: US 2024/0376381 A1
(43) Pub. Date: Nov. 14, 2024

(54) METHOD FOR SYNTHESISING COLLOIDAL SUSPENSIONS OF NANORODS

(71) Applicants: ECOLE POLYTECHNIQUE, Palaiseau (FR); CENTRE NATIONAL DE LA RECHERCHE SCIENTIFIQUE, Paris (FR)

(72) Inventors: Thierry GACOIN, Bures sur Yvette (FR); Jongwook KIM, Paris (FR); Zijun WANG, Villebon-sur-Yvette (FR); Qilin ZOU, Massy (FR)

(21) Appl. No.: 18/688,894

(22) PCT Filed: Sep. 5, 2022
(86) PCT No.: PCT/EP2022/074632

§ 371 Date: Mar. 4, 2024

(30) Foreign Application Priority Data
Sep. 6, 2021 (FR) FR2109316

(51) Int. Cl. C09K 11/77; B82Y 20/00; B82Y 40/00; C01B 25/45

(52) U.S. Cl. CPC C09K 11/7795; C01B 25/45; B82Y 20/00; B82Y 40/00; C01P 2002/52; C01P 2004/16; C01P 2004/54; C01P 2004/62; C01P 2004/64; C01P 2006/60

(57) ABSTRACT

A process for synthesizing La1-a-bAaBbPO4 nanorods, A being chosen from Y, Sc, Ce, Pr, Nd, Pm, Sm, Gd, Tb and mixtures thereof, B being a luminescence-activating dopant chosen from Eu, Yb, Er, Tm, Dy, Ho and mixtures thereof, with 0≤a≤0.5 and 0≤b≤0.2 the process involving: a. the preparation of an acidic mother liquor having a pH of between 1.0 and 3.0 by mixing at least, or even by mixing only: a solvent, a first constituent providing La3+ ions, a second constituent, in excess, providing PO43− ions, if a>0, a third constituent providing A3+ ions, if b>0, a constituent providing luminescence-activating dopant ions B3+, in amounts such that, in the mother liquor, the ratio of the number of moles of PO43− ions to the number of moles of La3+ ions and, where appropriate, A3+ and/or B3+ ions is between 1.10 and 1.50, and b. heating the mother liquor under hydrothermal conditions at a heating temperature above 120° C. until La1-a-bAaBbPO4 nanorods of monazite crystallographic structure are obtained.

The present invention relates to the synthesis of oxide particles in the form of nanorods. The invention also relates to a nanorod powder, notably manufactured via the process according to the invention, and also to a solution in which the nanorods are dispersed.

### PRIOR ART

It is notably known from the article “Polarized Luminescence of Anisotropic LaPO₄:Eu Nanocrystal Polymorphs”, E. Chaudan et al., J. Am. Chem. Soc. 2018, 140, 9512-9517, doi:10.2021/jacs.8b03983, that europium-doped lanthanum phosphate nanorods with a rhabdophane crystal phase exhibit polarized luminescence properties, i.e. their emission intensity at a given wavelength depends on the orientation of the nanorods relative to a detector equipped with an analytical polarizer. Such nanorods, obtained by hydrothermal synthesis, have excellent colloidal properties, as described in J. Kim et al., Advanced Functional Materials 22 (23), 4949-4956, doi: 10.1002/adfm.201200825. In other words, when dissolved in an acidic solution at a pH equal to 2 or in ethylene glycol, these nanorods are dispersed and do not substantially agglomerate together. Thus, each nanorod is distant from the other nanorods in the solution.

Such a polarized luminescence property can be exploited in a variety of applications. For example, it allows the orientation of biological molecules to be monitored, or can be used to measure the shear field in a liquid in which LaPO₄:Eu nanorods are dispersed. The nanorods then orient themselves locally differently as a function of the local shear. The articles J. Kim et al., Nature Communications, 12 (1), 1-10, 2021 and “Monitoring the orientation of rare-earth-doped nanorods for flow shear tomography”, J. Kim et al., Nature Nanotechnology, volume 12, pages 914-919 (2017), doi:10.1038/nnan0.2017.111, describe such a measurement method.

In the article “Polarized Luminescence of Anisotropic LaPO₄:Eu Nanocrystal Polymorphs” presented above, the authors also describe europium-doped lanthanum phosphate in the monazite crystal phase formed from the rhabdophane phase, by heat treatment at a temperature of between 200° C. and 1000° C. The authors were thus able to observe that the monazite crystal phase exhibits superior polarized luminescence properties to those of the rhabdophane crystal phase.

However, the europium-doped lanthanum phosphate with a monazite crystal phase thus obtained has a microcrystalline form that makes it unsuitable for redispersion in a liquid, as the heat treatment annihilates the colloidal properties of said phosphate.

It is also known from the article “Wet-Chemical Synthesis of Doped Colloidal Nanomaterials: Particles and Fibers of LaPO₄:Eu, LaPO₄:Ce, and LaPO₄:Ce,Tb”, H. Meyssamy et al., Adv. Mater. 1999, Vol. 11, No. 10, a solvothermal synthetic process for monazite-phase LaPO₄:Eu nanorods. The dispersibility of the nanorods is not described in said article. Transmission microscopy photographs are presented, showing aggregates of nanorods aggregated together.

There is thus a need for a process for synthesizing nanorods of a phosphate- and lanthanum-based material of monazite crystal structure, preferably exhibiting polarized luminescence properties, which can form a colloidal dispersion substantially free of nanorod aggregates.

### SUMMARY OF THE INVENTION

The invention relates to a process for synthesizing La_{1-a-b}AₐB_{b}PO₄ nanorods, A being chosen from Y, Sc, Ce, Pr, Nd, Pm, Sm, Gd, Tb and mixtures thereof, B being a luminescence-activating dopant chosen from Eu, Yb, Er, Tm, Dy, Ho and mixtures thereof, with 0≤a≤0.5 and 0≤b≤0.2 the process involving:
a. the preparation of an acidic mother liquor having a pH of between 1.0 and 3.0 by mixing at least, or even by mixing only:
   a solvent,
   a first constituent providing La³⁺ ions,
   a second constituent, in excess, providing PO₄³⁻ ions,
   if a>0, a third constituent providing A³⁺ ions,
   if b>0, a constituent providing luminescence-activating dopant ions B³⁺, in amounts such that, in the mother liquor, the ratio of the number of moles of PO₄³⁻ ions to the number of moles of La³⁺ ions and, where appropriate, A³⁺ ions and/or B³⁺ ions is between 1.10 and 1.50,
b. heating the mother liquor under hydrothermal conditions at a heating temperature above 120° C. until La_{1-a-b}AₐB_{b}PO₄ nanorods of monazite crystallographic structure are obtained.

The inventors have found that the preparation of a mother liquor in which the concentration of PO₄³⁻ ions is in excess relative to the stoichiometric conditions for the reaction to form the material of formula La_{1-a-b}AₐB_{b}PO₄ and in the proportions of the invention, allows the simple production of monazite-phase nanorods. When placed in a solution with a pH of between 1 and 3, preferably about 2, the nanorods are easily dispersed and form a colloidal solution without substantially forming aggregates.

Furthermore, the monazite-phase nanorods obtained via the process according to the invention, in the variant in which they are Europium-doped, exhibit emission in the red wavelengths, i.e. between 580 nm and 720 nm, with narrow emission peaks and significant polarization dependence for both electric and magnetic dipole transitions. Thus, the monazite nanorods obtained via the process of the invention are suitable for forming precise probes for orientation analyses, of the type described in the article “Monitoring the orientation of rare-earth-doped nanorods for flow shear tomography”.

Preferably, the amounts of the first and second constituents are such that the ratio of the number of moles of PO₄³⁻ ions to the number of moles of La ions and, where appropriate, A³⁺ ions and/or B³⁺ ions is between 1.15 and 1.25, preferably equal to 1.20.

Preferably, the pH of the mother liquor is between 1.9 and 2.1, preferably equal to 2.0.

In particular, in step a), the pH may modified by adding an acid. The acid may be chosen from HCl, HNO₃, C₂HF₃O₂, H₂SO₄, HClO₄ and mixtures thereof. Preferably, the acid is nitric acid HNO₃.

The concentration of La³⁺ ions in the mother liquor may be between 0.01 mol/1 and 0.5 mol/l, for example about 0.05 mol/l.

The first constituent may be chosen from lanthanum nitrate, lanthanum chloride, lanthanum sulfate, lanthanum acetate, lanthanum oxide and mixtures thereof.

Preferably, the first constituent is lanthanum nitrate La(NO₃)₃.

The second constituent may be chosen from an ammonium salt, a sodium salt, a potassium salt and mixtures thereof. The second constituent may be chosen from (NH₄)₂HPO₄, Na₂HPO₄, NaH₂PO₄, Na₃PO₄ and mixtures thereof.

Preferably, the second constituent is diammonium phosphate (NH₄)₂HPO₄.

The third constituent providing A³⁺ ions may be chosen from a nitrate, chloride, perchlorate, sulfate, acetate, oxide of element A and mixtures thereof.

Preferably, the element A is yttrium.

The coefficient a may be less than or equal to 0.4, less than or equal to 0.3, less than or equal to 0.2, less than or equal to 0.1.

In a preferred embodiment, the coefficient a is equal to 0 so as to manufacture La_{1-b}B_{b}PO₄ nanorods.

The luminescence-activating dopant B may be chosen from Eu, Yb, Er and mixtures thereof. Preferably, the luminescence-activating dopant is europium Eu, which imparts excellent polarized photoluminescence properties to the nanorods.

The constituent providing the luminescence-activating dopant may be chosen from a nitrate, a chloride, a perchlorate, a sulfate, an acetate, an oxide of the luminescence-activating dopant, and mixtures thereof.

Preferably, the constituent providing the luminescence-activating dopant is europium nitrate Eu(NO₃)₃.

Preferably, the coefficient b is between 0.02 and 0.1, for example about 0.05.

The luminescence-activating dopant may be provided by the first constituent and/or by the second constituent. For example, lanthanum nitrate may be doped with europium nitrate.

The solvent may be polar. It is preferably chosen from water, a polyol, and mixtures thereof. The polyol may be chosen from diethylene glycol, glycerol and mixtures thereof. Preferably, the solvent is water.

Moreover, preferably, the preparation of the mother liquor also involves the mixing of a complexing agent. In this way, the cations, notably on the surface of the nanorods being formed, may be complexed. The length and aspect ratio of the nanorods can thus be effectively controlled.

The complexing agent is preferably chosen from sodium citrate, sodium oxalate, sodium tripolyphosphate, ethylenediaminetetraacetic acid disodium salt dihydrate and mixtures thereof.

Preferably, the complexing agent is ethylenediaminetetraacetic acid disodium salt dihydrate, known by the abbreviation EDTA-Na₂.

Preferably, the complexing agent is added to the mixture in a proportion such that the ratio of the number of moles of La³⁺ ions, and where appropriate A³⁺ ions and/or B³⁺ ions, to the number of moles of complexing agent, is between 10 and 5000, preferably greater than or equal to 1000.

In step b), the mother liquor is preferably heated to a temperature below 200° C. Such a heating temperature allows the nanorod aggregation to be limited.

The heating temperature is essentially greater than 120° C., to ensure the formation of the monazite phase.

Preferably, the heating temperature is less than or equal to 160° C. The luminescence emission of the nanorods is optimal in this heating temperature range. In addition, such a heating temperature range favors the production of nanorods with a high aspect ratio, notably greater than 20. It also enables the nanorod growth and aggregation to be limited.

Preferably, the mother liquor is kept at the heating temperature for at least 1 hour.

Preferably, the heating of the mother liquor is performed by means of a microwave reactor, which allows a rapid temperature rise of the mother liquor favoring the formation of nanorods. In addition, the use of a microwave reactor improves the reproducibility of the synthesis.

In particular, the heating rate in step b) may be greater than 60° C./min.

Step b) is performed under hydrothermal conditions. Preferably, in step b), the heating of the mother liquor is performed at a pressure of between 10⁵ Pa and 20×10⁵ Pa.

Preferably, at the end of step b), the nanorods are preferably less than 1000 nm long, or even less than 500 nm, or even less than 300 nm.

Preferably, the nanorods have an aspect ratio, defined as the ratio of the length of a nanorod to the width of a nanorod, of less than 100, or even less than 70, or even less than 50, preferably between 5 and 30, preferably between 15 and 30.

The process may include a step c), successive to step b), of washing and dissolving the nanorods, preferably by dialysis, to form a nanorod dispersion. Step c) allows the pH to be adjusted, the ionic strength to be reduced and the electrostatic repulsion between the nanorods to be increased. The nanorods can be dissolved in an acidic solution with a pH of between 1 and 3, for example a nitric acid solution with a pH equal to 2.

The process may include a drying step d), successive to step b) or, where appropriate, step c). The drying may be performed at a temperature above 50° C., for example 100° C., and for a period of between 30 minutes and 12 hours, for example 1 hour.

Finally, the invention relates to a colloidal dispersion of monazite-phase La_{1-a-b}AₐB_{b}PO₄ nanorods with A, B, a and b as described above.

Preferably, the transmittance of the dispersion to radiation at a wavelength of 500 nm, measured for a nanorod concentration of 20 mg/ml in aqueous solution, is greater than 50%/cm, i.e. for an optical path length of 1 cm through the dispersion. Such a transmittance is characteristic of a dispersion in which the particles are substantially not aggregated.

The “transmittance” corresponds to the ratio of the intensity of the radiation transmitted by the dispersion to the intensity of the incident radiation.

Preferably, the pH of the colloidal dispersion is less than or equal to 3.0. Preferably, the colloidal dispersion contains a solvent in which the nanorods are dispersed, the solvent being chosen from water, ethylene glycol, glycerol, dimethyl sulfoxide and mixtures thereof.

Preferably, the nanorods are obtained via the process according to the invention.

### Definitions

A “nanorod” is an anisotropic particle of generally elongated shape, i.e. extending mainly along a directrix which may be curvilinear or, preferably, rectilinear. Preferably, the length, measured along this directrix, is at least 10 times greater than the width, the width being the largest dimension that can be measured in all transverse planes, i.e. perpendicular to the directrix, along the directrix. In addition, the thickness, i.e. the smallest dimension measured in the transverse plane in which the width is measured, is greater than 0.5 times the width.

A “nanorod” has a length of less than 1000 nm.

The “length” of a nanorod may be measured by scanning electron microscopy, transmission electron microscopy or dynamic light scattering.

The “mean” length is the arithmetic mean of the lengths.

A nanorod “cluster” is formed by the aggregation of at least two nanorods.

Unless otherwise indicated, the percentages are numerical percentages.

### BRIEF DESCRIPTION OF THE FIGURES

Other features and advantages of the invention will emerge more clearly on reading the following detailed description and on examining the appended drawing, in which:

FIG. 1 is a graph representing the evolution of the transmittance of the dispersion of Example 1 as a function of the wavelength of the incident radiation,

FIG. 2 represents the diffraction patterns of the powders obtained by Examples 1 and 2 after different heating times;

FIG. 3 represents the diffraction patterns of the powder obtained according to Example 1 and of the bulk material obtained according to Comparative Example 3;

FIG. 4 includes scanning microscopy images of nanorod powders;

FIG. 5 represents a) the evolution of the Zeta potential of a nanorod solution as a function of the pH of the solution and b) is a photograph of said solution;

FIG. 6 represents the luminescent emission spectrum of a nanorod under illumination by ultraviolet radiation of wavelength 394 nm as a function of the polarization angle of a filter relative to the axis of the nanorod; and

FIG. 7 are transmission electron microscopy photographs of nanorods obtained according to Examples 4 to 8 for different La:EDTA-Na₂, ratios, the scale bar on each photograph corresponding to 50 nm.

### EXAMPLES

The following starting materials from the company Sigma-Aldrich were used, without further purification, for the examples:
lanthanum nitrate hexahydrate La(NO₃)₃·6H₂O, purity greater than 99.99%,
lanthanum oxide La₂O₃, purity greater than 99.9%,
europium nitrate pentahydrate Eu(NO₃)₃·5H₂O, purity greater than 99.99%,
europium oxide Eu₂O₃, purity greater than 99.9%,
diammonium phosphate ((NH₄)₂HPO₄, Analytical Reagent, A.R.),
nitric acid HNO₃, 70%, A.R.

### Example 1 According to the Invention

10 ml of an aqueous solution containing 0.0475 mol/1 La(NO₃)₃ and 0.0025 mol/1 Eu(NO₃)₃ were mixed in a tube with 12 ml of an aqueous solution containing 0.05 mol/1 (NH₄)₂HPO₄.

The diammonium phosphate was in excess in the mother liquor.

Its amount was such that the ratio of the number of PO₄³⁻ ions divided by the number of La³⁺ ions and Eu³⁺ ions was 1.2.

The amount of Eu(NO₃)₃ was chosen so that the Eu³⁺ dopant concentration was 5%, expressed as a percentage of the total number of La³⁺ and Eu³⁺ ions.

Precipitation of rhabdophane-phase La_{0.95}Eu_{0.05}PO₄ nanorods was observed as soon as the various constituents were placed in contact.

The mixture thus obtained, with a pH of 2, was then heated in a CEM brand Discover SP microwave reactor, to a heating temperature of 160° C. and maintained at this heating temperature for 2 hours.

After cooling, the La_{0.95}Eu_{0.05}PO₄ nanorods were collected by centrifugation at 8000×g for 20 minutes, and then dispersed in an aqueous nitric acid solution with a pH equal to 2. The suspension thus obtained was then dialyzed for 2 days through a membrane with a permeability of between 12 and 14 kDa against an aqueous nitric acid solution with a pH equal to 2.

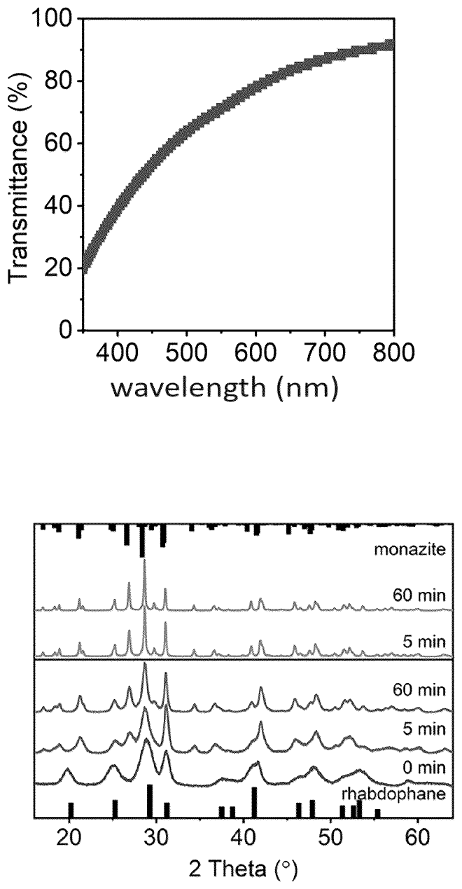

The nanorods were redispersed in an aqueous nitric acid solution with a pH of 2. The volumetric concentration of nanorods in the solution was 0.4% (i.e. a content of 20 mg/ml). The transmittance of the dispersion at 500 nm, measured after 1 year, was greater than 55%, as shown in FIG. 1.

Powder samples were then obtained by drying the redispersed suspension at a drying temperature of 100° C. for 12 hours.

### Comparative Example 2

10 ml of an acidic aqueous solution containing 0.4 mol/l HNO₃, 0.0475 mol/1 La(NO₃)₃ and 0.0025 mol/1 Eu(NO₃)₃ were mixed in a tube with 10 ml of an aqueous solution containing 0.05 mol/1 (NH₄)₂HPO₄.

The constituents La(NO₃)₃ and (NH₄)₂HPO₄ were thus present in stoichiometric amounts.

The amount of Eu(NO₃)₃ was chosen such that the Eu³⁺ dopant concentration was 5%, in percentages expressed on the basis of the total number of La³⁺ and Eu³⁺ ions.

No precipitation of La_{0.95}Eu_{0.05}PO₄ was observed after mixing.

The mixture thus obtained, with a pH of 0.4, was then heated in the microwave reactor to a heating temperature of 160° C. and maintained at this temperature for 2 hours.

After cooling, La_{0.95}Eu_{0.05}PO₄ nanorods were collected by centrifugation at 8000×g for 20 minutes, and then dispersed in an aqueous nitric acid solution with a pH equal to 2. The suspension thus obtained was then dialyzed for 2 days through a membrane with a permeability of between 12 and 14 kDa against an aqueous nitric acid solution with a pH equal to 2.

Powder samples were then obtained by drying the dialyzed suspension at a drying temperature of 100° C. for 12 hours.

### Comparative Example 3: Solid-State Synthesis

Lanthanum oxide, europium oxide and diammonium phosphate were mixed under stoichiometric conditions and ground in an agate mortar. The ground material was then heated at 800° C. for 1 hour, cooled and then maintained at 1100° C. for 12 hours. Lanthanum phosphate doped with 5% europium in bulk form, i.e. grains larger than several microns in size, was thus obtained.

### Examples 4 to 8 According to the Invention

12 ml of an aqueous solution containing 0.05 mol/1 of (NH₄)₂HPO₄ and one volume of ethylenediaminetetraacetic acid disodium salt dihydrate (EDTA-Na₂) were mixed to form a first mixture. After stirring for 30 minutes, 10 ml of an aqueous solution containing 0.04 mol/1 La(NO₃)₃ and 0.01 mol/1 Eu(NO₃)₃ were added to the first mixture.

The volume of ethylenediaminetetraacetic acid disodium salt dihydrate (EDTA-Na₂) in the first mixture was chosen so that, in the mother liquor, the ratio La:EDTA-Na₂ of the total number of moles of La³⁺ and Eu³⁺ ions to the number of moles of EDTA-Na₂ was as indicated in Table 1.

TABLE 1

| Example | La:EDTA-Na₂ |
|---|---|
| 4 | 10 |
| 5 | 50 |
| 6 | 100 |
| 7 | 1000 |
| 8 | 5000 |

The diammonium phosphate was in excess in the mother liquor. Its amount was such that the ratio of the number of PO₄³⁻ ions divided by the number of La³⁺ ions and Eu³⁺ ions was 1.2.

The amount of Eu(NO₃)₃ was chosen so that the Eu³⁺ dopant concentration was 20%, expressed as a percentage of the total number of La³⁺ and Eu³⁺ ions.

The mother liquor thus prepared was stirred for 30 minutes.

Precipitation of rhabdophane-phase La_{0.8}Eu_{0.2}PO₄ nanorods was observed as soon as the various constituents were placed in contact.

The mother liquor, with a pH of 2, was then heated in a CEM brand Discover SP microwave reactor, to a heating temperature of 160° C. and maintained at this heating temperature for 2 hours.

After cooling, the La_{0.8}Eu_{0.2}PO₄ nanorods were collected by centrifugation at a speed of 11 000 rotations per minute for 30 minutes, and then washed twice in succession in a nitric acid solution with a pH equal to 2 to extract the excess EDTA-Na₂.

Finally, the La_{0.8}Eu_{0.2}PO₄ nanorods were dispersed in an aqueous nitric acid solution with a pH equal to 2. The suspension thus obtained was then dialyzed for 2 days through a membrane with a permeability of between 12 and 14 kDa against an aqueous nitric acid solution with a pH equal to 2.

### Characterization Methods

In order to characterize the various products obtained for Examples 1 to 3, the following methods were used.

Crystal phase characterizations were performed by X-ray diffraction with a Bruker® D8 Advance diffractometer using Cu Kα radiation of wavelength λ=1.5409 Å with a LynxEye® XE-T detector.

Morphology observations were performed using a Hitachi S4800 field-effect scanning electron microscope under an electron acceleration voltage of 5 kV. The samples to be observed were prepared by depositing a drop of solution including the nanorods on a copper grid coated with a 3 nm thick carbon coating.

Zeta potential measurements were taken using a Malvern® ZetaSizer Nano ZS device.

Emission spectra were measured using a superfluorometer (FluoroMax-4, Horiba®) equipped with a 150 W xenon lamp and a Hamamatsu R928P photomultiplier tube.

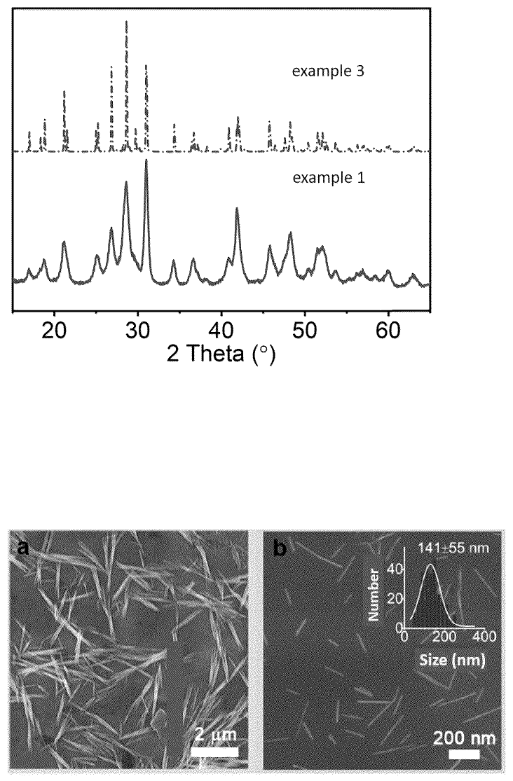

FIG. 2 represents the evolution for Examples 1 and 2 of diffractograms measured by X-ray diffraction prior to the heating step (0 min) and for different heating periods (5 min and 60 min) at 160° C.

The theoretical diffractograms of the rhabdophane and monazite phases are represented on the lower and upper horizontal axes, respectively.

The powder according to the invention obtained via the process according to the invention in Example 1 has a rhabdophane phase as soon as the constituents are mixed (0 min). After 5 minutes of heating time, a gradual transition from the rhabdophane phase to the monazite phase is observed. However, for short heating times, the diffraction peaks are relatively broad, indicating that the crystallite sizes are small. Increasing the heating time results in peaks that become narrower and narrower, indicating that the particles are increasing in size or are improving in crystallinity.

Moreover, the diffractogram of the powder of Example 1 according to the invention is substantially identical to the diffractogram of the material obtained by the solid route of comparative Example 3, as observed in FIG. 3.

In the case of Comparative Example 2, no particles are formed during the mixing of the constituents. However, heating results directly in monocrystalline particles of monazite phase.

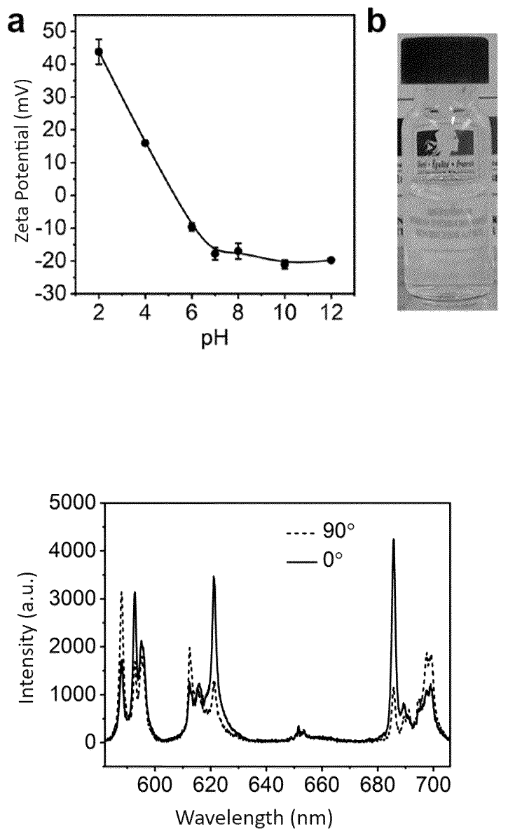

FIG. 4a) is a scanning microscopy photograph of the powder of Comparative Example 2. The nanorods are aggregated in clusters, most of them consisting of 5 to 30 nanorods. The powder of Example 2 has a mean length of 621 nm with a standard deviation of 135 nm. The nanorods have an aspect ratio of 100. The clusters have a mean length of about 620 nm and a width of about 60 nm.

FIG. 4b) is a scanning microscopy photograph of the powder of Example 1 according to the invention. The nanorods appear isolated and at a distance from each other. The nanorods of Example 1 have a mean length of 141 nm, with a standard deviation of 55 nm. The nanorods have an aspect ratio of 28 with a standard deviation of 11.

FIG. 5a) represents the evolution of the Zeta potential as a function of the pH in an aqueous solution including nanorods of Example 1 according to the invention.

The zero charge point is obtained at a pH of about 5.3. It is observed that for acidic pH values below the zero-point pH, the Zeta potential increases almost linearly with reducing pH and is 44 mV for a pH of 2, attesting to the excellent dispersibility of the nanorods.

This is confirmed by the observation in FIG. 4b), and also by the stability of the dispersion observed in FIG. 5b), which could be observed for over a year without any change in appearance, notably in terms of its light-scattering properties.

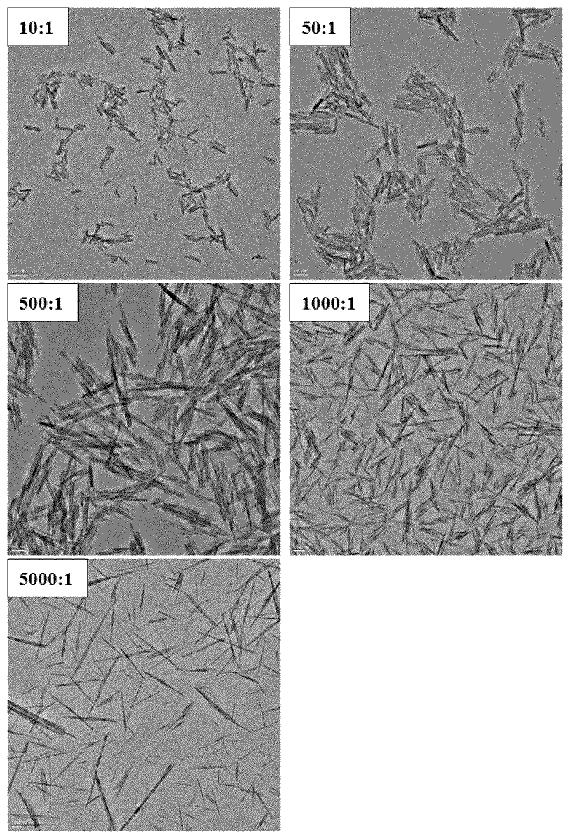

Finally, as shown in FIG. 6, the nanorods have a light emission spectrum that is polarized when illuminated by ultraviolet radiation with a wavelength equal to 394 nm. Changing the angle of a polarizing filter relative to the axis of a nanorod induces a variation in the intensity of certain radiation components.

This variation may notably be used to determine the orientation of the nanorods in a liquid, and to determine, for example, the local shear rate to which the liquid is subjected.

Table 2 indicates the characteristics of the nanorods obtained for Examples 4 to 8.

TABLE 2

| | | Mean | Mean | |
|---|---|---|---|---|
| | | length | width | Aspect |
| Example | La:EDTA-Na₂ | (nm) | (nm) | ratio |
| 4 | 10 | 37 | 7 | 5.3 |
| 5 | 50 | 71 | 9 | 7.9 |
| 6 | 100 | 97 | 11 | 8.8 |
| 7 | 1000 | 129 | 10 | 12.9 |
| 8 | 5000 | 182 | 10 | 18.2 |

It is seen that in the range tested, an increase in the La:EDTA-Na₂ ratio results in an increase in the mean length and aspect ratio of the nanorods, with the mean width of the nanorods varying only slightly with the La:EDTA-Na₂ ratio.

The addition of EDTA-Na₂ to the mother liquor thus allows simple modification of the length and aspect ratio of the nanorods, the ratio of the number of moles of La³⁺ ions and moles of Eu³⁺ to the number of moles of PO₄³⁻ being fixed.

The nanorods of Examples 4 to 8 are illustrated in the transmission microscopy photographs shown in FIG. 7, with the corresponding La:EDTA-Na₂ ratio indicated on each photograph. Different sampling methods were used to acquire the photographs, which do not allow the individual dispersion of the nanorods to be conserved. Aggregates were formed during this sampling. However, the inventors verified that in each colloidal dispersion of Examples 4 to 8, the nanorods were well dispersed. This was confirmed notably by comparing the results of measurements of the lengths of the nanorods by dynamic light scattering with the measurements of these lengths in the photographs in FIG. 7. This was also confirmed by the observation of the limpidity and stream birefringence of each colloidal dispersion.

Finally, X-ray diffraction analysis of Examples 4 to 8 revealed that the La_{0.8}Eu_{0.2}PO₄ nanorods have a monazite crystallographic structure.

Needless to say, the invention as claimed should not be understood as being limited to the examples of implementation of the process described by way of illustration.

1. A process for synthesizing La_{1-a-b}AₐB_{b}PO₄ nanorods, A being chosen from Y, Sc, Ce, Pr, Nd, Pm, Sm, Gd, Tb and mixtures thereof, B being a luminescence-activating dopant chosen from Eu, Yb, Er, Tm, Dy, Ho and mixtures thereof, with 0≤a≤0.5 and 0≤b≤0.2 the process involving:
a. the preparation of an acidic mother liquor having a pH of between 1.0 and 3.0 by mixing at least:
a solvent,
a first constituent providing La³⁺ ions,
a second constituent, in excess, providing PO₄³⁻ ions,
if a>0, a third constituent providing A³⁺ ions,
if b>0, a constituent providing luminescence-activating dopant ions B³⁺,
in amounts such that, in the mother liquor, the ratio of the number of moles of PO₄³⁻ ions to the number of moles of La³⁺ ions and, where appropriate, A³⁺ ions and/or B³⁺ ions is between 1.10 and 1.50,
b. heating the mother liquor under hydrothermal conditions at a heating temperature above 120° C. until La_{1-a-b}AₐB_{b}PO₄ nanorods of monazite crystallographic structure are obtained.

2. The process as claimed in claim 1, the amounts of the first and second constituents being such that the ratio of the number of moles of PO₄³⁻ ions to the number of moles of La³⁺ ions and, where appropriate, A³⁺ ions and/or B³⁺ ions is between 1.15 and 1.25, preferably equal to 1.20.

3. The process as claimed in claim 1, the first constituent being chosen from lanthanum nitrate, lanthanum chloride, lanthanum sulfate, lanthanum acetate, lanthanum oxide and mixtures thereof and/or the second constituent being chosen from (NH₄)₂HPO₄, Na₂HPO₄, NaH₂PO₄, Na₃PO₄ and mixtures thereof.

4. The process as claimed in claim 3, the second constituent being diammonium phosphate (NH₄)₂HPO₄ and/or the first constituent being lanthanum nitrate La(NO₃)₃.

5. The process as claimed in claim 1, the element A being yttrium.

6. The process as claimed in claim 1, the coefficient a being equal to 0.

7. The process as claimed in claim 1, the luminescence-activating dopant B being chosen from Eu, Yb, Er and mixtures thereof.

8. The process as claimed in claim 1, the mother liquor being heated in step b) to a heating temperature of less than 200° C.

9. The process as claimed in claim 1, the solvent being polar.

10. The process as claimed in claim 1, including a step c), successive to step b) of washing and dissolving the nanorods to form a nanorod dispersion.

11. The process as claimed in claim 10, step c) being performed by dialysis.

12. The process as claimed in claim 1, the nanorods at the end of step b) having a length of less than 500 nm.

13. The process as claimed in claim 1, the nanorods having an aspect ratio, defined as the ratio of the length of a nanorod to the width of a nanorod, of less than 100.

14. The process as claimed in claim 1, the preparation of the mother liquor also involving the mixing of a complexing agent.

15. The process as claimed in claim 14, the complexing agent being ethylenediaminetetraacetic acid disodium salt dihydrate.

16. The process as claimed in claim 14, the complexing agent being added to the mixture in a proportion such that the ratio of the number of moles of La³⁺ ions, and where appropriate A³⁺ ions and/or B³⁺ ions, to the number of moles of complexing agent, is between 10 and 5000.

17. A colloidal dispersion of La_{1-a-b}AₐB_{b}PO₄ nanorods, A being chosen from Y, Sc, Ce, Pr, Nd, Pm, Sm, Gd, Tb and mixtures thereof, B being chosen from Eu, Yb, Er, Tm, Dy, Ho and mixtures thereof, with 0≤a≤0.5 and 0≤b≤0.2.

18. The dispersion as claimed in claim 17, the transmittance of the dispersion to radiation at a wavelength of 500 nm, measured at a nanorod concentration of 20 mg/ml, being greater than 50%.
